(19) United States
(12) Patent Application Publication
(10) Pub. No.: US 2026/0339982 A1
(43) Pub. Date: Oct. 29, 2026

(54) SYSTEM AND METHOD FOR CONSENSUS CLUSTERING

(71) Applicant: RAPTORXAI PRIVATE LIMITED, Tellapur (IN)

(72) Inventors: Pratyusha Vemuri Venkata, Tellapur (IN); Zhongyuan Wang, Hangzhou (CN)

(21) Appl. No.: 19/636,773

(22) Filed: Apr. 1, 2026

(30) Foreign Application Priority Data
Apr. 2, 2025 (IN) 202541032797

(51) Int. Cl. G06F 16/28

(52) U.S. Cl. CPC G06F 16/285

(57) ABSTRACT

The present disclosure discloses a system and method for consensus clustering. The method includes receiving, a dataset comprising a plurality of data points; applying, a plurality of base clustering algorithms to the dataset; calculating, a weight for each of the plurality of base clustering algorithms, based on a performance metric; constructing, a co-association matrix to quantify the frequency of assigning pairs of data points to the same cluster across the plurality of base clustering algorithms, wherein the contribution of each of the plurality of base clustering algorithm is weighted based on the calculated weight; transforming the co-association matrix into a lower-dimensional Euclidean embedding using a dimensionality reduction technique; applying, a final clustering algorithm to the lower-dimensional Euclidean embedding; and classifying, a set of new data points into the plurality of consensus cluster assignments using a label propagation technique.

### FIELD OF THE INVENTION

The present disclosure generally relates to the field of machine learning and data clustering. In particular, the present invention pertains to a combination of clustering algorithms and ensemble methods used for analyzing multi-algorithm data to identify patterns.

### BACKGROUND OF THE INVENTION

The background information herein below relates to the present disclosure but is not necessarily prior art.

Clustering is a key task in machine learning used to group similar data points together. There are many applications of clustering in the areas of customer segmentation, fraud detection, medical diagnosis, and image processing. Many clustering algorithms exist, but each has its own limitations.

Traditional clustering techniques like K-means, Spectral Clustering, and DBSCAN may work well in certain cases but struggle in others and hence none of them is ultimate solution. K-means clustering algorithm is fast but assumes clusters are spherical, limiting its flexibility. Spectral Clustering technique may detect complex shapes but is slow due to lack of high computing power. DBSCAN clustering technique may be good at handling noise but struggles when clusters have different densities. Because no single method works best in all situations, researchers have developed ensemble clustering, that combines multiple algorithms to improve results.

Despite of combining multiple algorithms, ensemble clustering faces several critical challenges that hinder its effectiveness in large-scale, real-world applications. One major issue is the high-dimensional co-association matrix, which captures pairwise relationships between data points but becomes computationally intractable with the increasing dataset. This results in excessive memory consumption and slows down processing speed, making traditional ensemble methods impractical for big data environments. Additionally, many methods fail to properly transform non-Euclidean similarity data, leading to suboptimal clustering results. Since clustering relies on measuring distances or similarities, improper transformations reduce accuracy and compromise the quality of the final clusters.

Another key issue is the lack of a principled weighting mechanism for base clustering algorithms. Existing ensemble methods often assume all algorithms contribute equally or use heuristic-based weighting, that does not always reflect the actual quality of each clustering result. This can lead to biased or misleading final clusters. Another major concern is Computational inefficiency. Many ensemble approaches require significant processing power and memory, limiting their ability to scale up efficiently.

Beyond computational constraints, existing methods struggle with handling new data dynamically. In real-world applications, data continuously evolves, but most ensemble clustering techniques require re-running the entire clustering process when new data arrives. This lack of adaptability makes them unsuitable for real-time applications such as recommendation systems, fraud detection, and anomaly detection.

Owing to these challenges, there is a clear need for a more efficient, scalable, and adaptive ensemble clustering approach. that addresses high-dimensionality, improves similarity transformation, optimizes computational performance, and allows real-time updates. This invention presents a novel solution to overcome these limitations and enhance the effectiveness of ensemble clustering in practical applications.

### OBJECTS OF THE INVENTION

Some of the objects of the present disclosure, which at least one embodiment herein satisfy are as follows:

An object of the present disclosure is to develop an improved ensemble clustering method that is scalable, accurate, and adaptive for real-world applications.

Another object of the present disclosure is to reduce the computational complexity of the co-association matrix, enabling efficient handling of high-dimensional data.

Another object of the present disclosure is to introduce an optimized transformation technique to convert non-Euclidean similarity spaces into a more suitable format for clustering.

Still another object of the present disclosure is to implement a principled weighting mechanism that assigns appropriate importance to base clustering algorithms based on their contributions.

Yet another object of the present disclosure is to enhance computational efficiency, allowing large-scale datasets to be processed with minimal resource usage.

One more object of the present disclosure is to enable dynamic cluster adaptation, allowing cluster assignments to be updated incrementally with the arrival of new data each time.

Yet another object of the present disclosure is to eliminate the need for complete re-clustering, making the method suitable for real-time applications.

Another object of the invention is to improve the accuracy, robustness, and practicality of ensemble clustering across various machine learning and data analysis domains.

Yet another object of the invention is to enable real-time clustering applications wherein dynamically changing data must be continuously analysed to identify suspicious activities.

Other objects and advantages of the present disclosure will be more apparent from the following description when read in conjunction with the accompanying figures, which are not intended to limit the scope of the present disclosure.

### SUMMARY OF THE INVENTION

The present disclosure envisages a system and method for consensus clustering. The present invention provides a method, system, and non-transitory computer-readable storage medium for consensus clustering, which enhances clustering performance by leveraging multiple base clustering algorithms and weighting their contributions based on a performance metric.

The present disclosure further envisages an advanced consensus clustering method for multi-algorithm data integration and analysis. The method includes:
receiving a dataset comprising a plurality of data points;
applying a plurality of base clustering algorithms to the dataset, for producing a set of cluster assignments for the data points by each of the plurality of base clustering algorithms;
calculating a weight for each of the plurality of base clustering algorithms, based on a performance metric;
constructing a co-association matrix to quantify the frequency of assigning pairs of data points to the same cluster across the plurality of base clustering algorithms, wherein the contribution of each of the plurality of base clustering algorithm is weighted based on the calculated weight;
transforming the co-association matrix into a lower-dimensional Euclidean embedding using a dimensionality reduction technique;
applying a final clustering algorithm to the lower-dimensional Euclidean embedding to generate a plurality of consensus cluster assignments for the data points; and
classifying a set of new data points into the plurality of consensus cluster assignments using a label propagation technique and generating a set of predicted cluster labels.

The method begins by receiving a dataset containing multiple data points. A plurality of base clustering algorithms is applied to generate initial cluster assignments. Each base clustering algorithm is assigned a weight based on a performance metric, such as a silhouette score. A co-association matrix is constructed to capture the frequency of data points being assigned to the same cluster across different base clustering algorithms, with the contributions of each algorithm weighted accordingly.

The method of constructing the co-association matrix comprises the steps of:
partitioning the dataset by each of the plurality of base clustering algorithms, based on the cluster assignments;
determining for each pair of data points, if the pair of data point is assigned to the same cluster by each of the plurality of base clustering algorithms; and
combining the determinations with the calculated weights based on the performance of each of the plurality of base clustering algorithms.

To optimize clustering performance, the co-association matrix is transformed into a lower-dimensional Euclidean embedding using a dimensionality reduction technique, such as Principal Component Analysis (PCA). A final clustering algorithm, such as K-means, is then applied to the transformed data to obtain consensus cluster assignments. New data points are classified into the generated clusters using a label propagation technique, implemented via a K-Nearest Neighbors (KNN) classifier operating in the lower-dimensional embedding space.

The method for predicting consensus cluster assignments comprises the steps of:
receiving the set of new data points that were not part of the original dataset;
training the KNN classifier on the original data points and the respective consensus cluster assignments; and
predicting the plurality of consensus cluster assignments, using the KNN classifier for the set of new data points.

The present invention further includes a system comprising a repository storing clustering instructions and a plurality of processors executing clustering operations. The system is equipped with various modules, including a data preprocessing module, a base clustering module, a co-association matrix construction module, an embedding transformation module, a final clustering module, and a label propagation module. The system dynamically selects base clustering algorithms based on data characteristics and ensemble diversity metrics, ensuring adaptability to different datasets.

The repository is configured to store a set of predetermined instructions, a formula for calculating weights based on a silhouette score, a formula for computing co-association matrix, a set of new data points, and KNN classification technique.

The plurality of processors is coupled to the repository to execute the set of predetermined instructions required for operating the different modules in the system.

Each of the plurality of processors further comprises a data preprocessing module, a base clustering module, a co-association matrix construction module, an embedding transformation module, a final clustering module, and a label propagation module.

The data preprocessing module is configured to receive a dataset comprising a plurality of data points for pre-processing.

The base clustering module is configured to apply a plurality of base clustering algorithms to the dataset, for producing a set of cluster assignments for the data points by each of the plurality of base clustering algorithms. The base clustering module is further configured to dynamically selects the base clustering algorithms based on data characteristics and an ensemble diversity metric.

The base clustering module is further configured to calculate a weight for each of the plurality of base clustering algorithms based on a performance metric. The performance metric for calculating the weight of each of the plurality of base clustering algorithms is the silhouette score. The weighting mechanism dynamically updates silhouette score-based weights with the generation of every new clustering result.

The system dynamically updates weights and cluster assignments with each new clustering result to maintain accuracy.

The co-association matrix construction module is configured to construct a co-association matrix to quantify the frequency of assigning pairs of data points to the same cluster across the plurality of base clustering algorithms, wherein the contribution of each of the plurality of base clustering algorithm is weighted based on the calculated weight. The co-association matrix construction module is further configured to select a random subset of the data for constructing the co-association matrix for large datasets.

Further, the embedding transformation module is configured to transform the co-association matrix into a lower-dimensional Euclidean embedding using a dimensionality reduction technique.

The final clustering module is configured to apply a final clustering algorithm to the lower-dimensional Euclidean embedding to generate a plurality of consensus cluster assignments for the data points. The embedding transformation module is further configured to optimize the number of principal components retained based on a variance threshold.

The label propagation module is configured to classify a set of new data points into the plurality of consensus cluster assignments using a label propagation technique and generate a set of predicted cluster labels. The label propagation module implements a K-Nearest Neighbors (KNN) classifier in the lower-dimensional Euclidean embedding for classification. The label propagation module is further configured to propagate the results to the full dataset using the K-Nearest Neighbors (KNN) classifier. The K-Nearest Neighbors (KNN) classifier utilizes a distance metric accounting for variance-scaled feature representation in the transformed embedding space.

Hence the system is designed to effectively perform consensus clustering. By integrating weighted ensemble clustering, dimensionality reduction, and label propagation, the present invention provides an efficient and robust approach to clustering data, enabling improved classification of new data points while maintaining computational efficiency.

### BRIEF DESCRIPTION OF THE DRAWINGS

Advanced consensus clustering system and method for multi-algorithm data integration and analysis, of the present disclosure will now be described with the help of the accompanying drawings, in which:

FIG. 1 illustrates a block diagram for the overall architecture of the consensus clustering system, in accordance with the present disclosure.

FIG. 2 illustrates a flowchart depicting the process of constructing the co-association matrix from multiple base clustering algorithms of FIG. 1, in accordance with the present disclosure.

FIG. 3 illustrates the transformation of the co-association matrix into a lower-dimensional embedding using Principal Component Analysis, in accordance with the present disclosure.

FIG. 4 illustrates flowchart illustrating the process of applying the final clustering algorithm on the embedding and propagating labels to new data points of FIG. 1, in accordance with the present disclosure.

FIG. 5 illustrates the method for executing consensus clustering on the system of FIG. 1, in accordance with the present disclosure.

### DETAILED DESCRIPTION OF THE INVENTION

Embodiments, of the present disclosure, will now be described with reference to the accompanying drawing.

Embodiments are provided to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only to explain a particular embodiment and such terminology shall not be considered to limit the scope of the present disclosure. As used in the present disclosure, the forms “a”, “an”, and “the” may be intended to include the plural forms as well, unless the context suggests otherwise. The terms “comprises”, “comprising”, “including”, and “having”, are open-ended transitional phrases and therefore specify the presence of stated features, elements, modules, units, and/or components, but do not forbid the presence or addition of one or more other features, elements, components, and/or groups thereof. The particular order of steps disclosed in the method and process of the present disclosure is not to be construed as necessarily requiring their performance as described or illustrated. It is also to be understood that additional or alternative steps may be employed.

When an element is referred to as being “mounted on”, “engaged to”, “connected to”, or “coupled to” another element, it may be directly on, engaged, connected, or coupled to the other element.

As used herein, the term “and/or” includes any and all combinations of one or more of the associated listed elements.

The terms first, second, third, etc., should not be construed to limit the scope of the present disclosure as the aforementioned terms may be only used to distinguish one element or component from another element or component. Terms such as first, second, third etc., when used herein do not imply a specific sequence or order unless clearly suggested by the present disclosure.

Existing consensus clustering methods have several drawbacks, including high computational complexity due to large co-association matrices, making them inefficient for big data applications. Many fail to properly transform non-Euclidean similarity spaces, leading to inaccurate clustering. The lack of a principled weighting mechanism results in unreliable consensus outputs. Additionally, these methods are memory-intensive, computationally expensive, and struggle with scalability. Most cannot incrementally update clusters, making them unsuitable for real-time applications where data evolves continuously.

To address these limitations, there is a clear need for a more efficient, scalable, and adaptive ensemble clustering approach that addresses high-dimensionality, improves similarity transformation, optimizes computational performance, and allows real-time updates. The present invention presents a novel solution to overcome these limitations and enhance the effectiveness of ensemble clustering in practical applications.

There remains a significant unmet need for a solution that is highly effective, optimizing computational performance, and accommodating real time data updates.

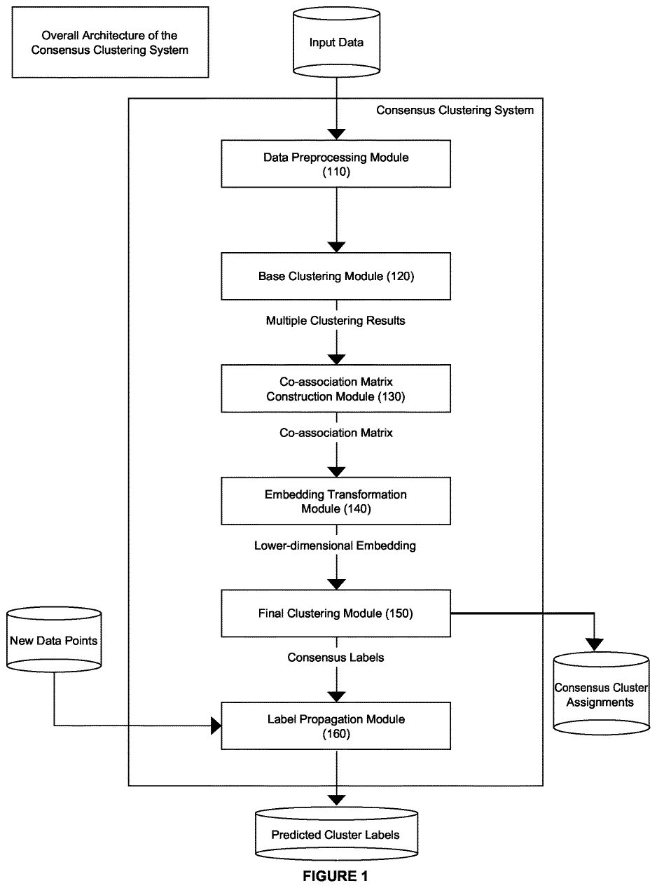

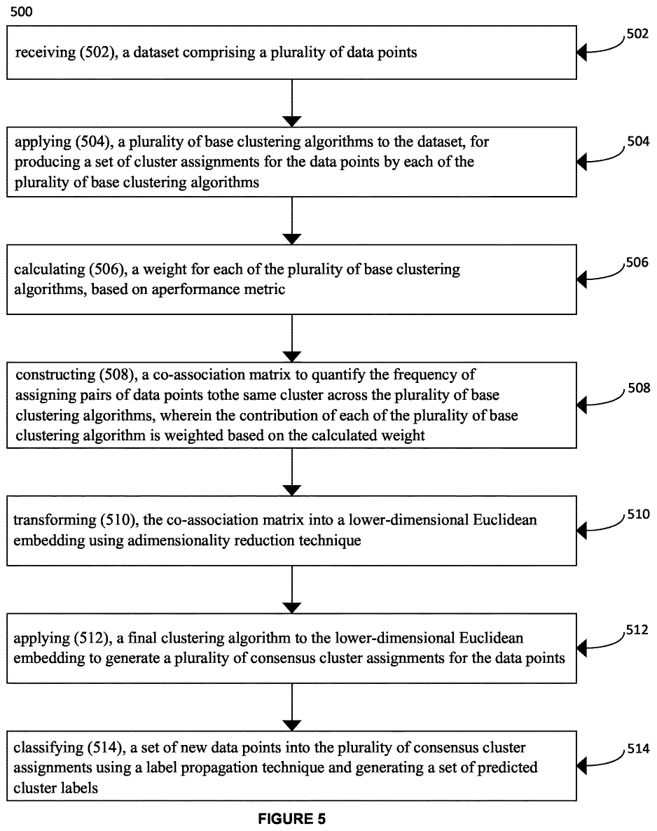

To alleviate the aforementioned shortcomings of the existing technologies, an advanced consensus clustering system for consensus clustering (hereinafter referred to as (“system 100”) and a method for consensus clustering (hereinafter referred to as “method 500”) are now being described with reference to FIGS. 1 and 5.

The present invention envisages a system 100 and method 500 for consensus clustering.

Referring to FIG. 1, the system 100 for consensus clustering. The FIG. 1 illustrates the overall architecture of the consensus clustering system 100. The FIG. 1 provides a structured representation of how input data is processed through various modules to generate consensus cluster assignments and predict cluster labels for new data points.

The system 100 comprises a repository 102 and a plurality of processor 104.

The repository 102 is configured to store a set of predetermined instructions, a formula for calculating weights based on a silhouette score, a formula for computing co-association matrix, a set of new data points, and KNN classification technique.

The plurality of processors 104 is coupled to the repository 102 to execute the set of predetermined instructions required for operating the different modules in the system 102.

Each of the plurality of processors further comprises a data preprocessing module 110, a base clustering module 120, a co-association matrix construction module 130, an embedding transformation module 140, a final clustering module 150, and a label propagation module 160.

The FIG. 1 represents the architecture of the consensus clustering system, consisting of multiple processing modules operating sequentially to generate reliable cluster assignments. The system 100 begins by receiving input data. Then the input data is processed through the data preprocessing module 110 to clean and normalize the dataset. The processed data is then passed to the base clustering module 120, where multiple base clustering algorithms generate different cluster assignments. The base clustering algorithms are selected from the list but not limiting to K-Means, Spectral Clustering, DBSCAN, and Other Algorithms.

The clustering results from the base clustering algorithms are then used by the co-association matrix construction module 130 to build a co-association matrix, that captures the frequency of data points being assigned to the same cluster across different clustering methods. This matrix is subsequently transformed into a lower-dimensional Euclidean space using the embedding transformation module 140, where dimensionality reduction techniques, such as Principal Component Analysis (PCA), optimize the feature space.

Once the data is represented in the lower-dimensional space, the final clustering module 150 applies a clustering algorithm, such as K-means, to generate consensus cluster assignments. The resulting consensus labels are then utilized by the label propagation module 160 to classify new data points based on their proximity to existing clusters. The label propagation module 160 employs a K-Nearest Neighbors (KNN) classifier to predict cluster labels for previously unseen data points.

The flowchart also highlights the relationship between new data points, consensus labels, and predicted cluster labels, demonstrating how the system maintains adaptability to incoming data while ensuring consistency in clustering performance.

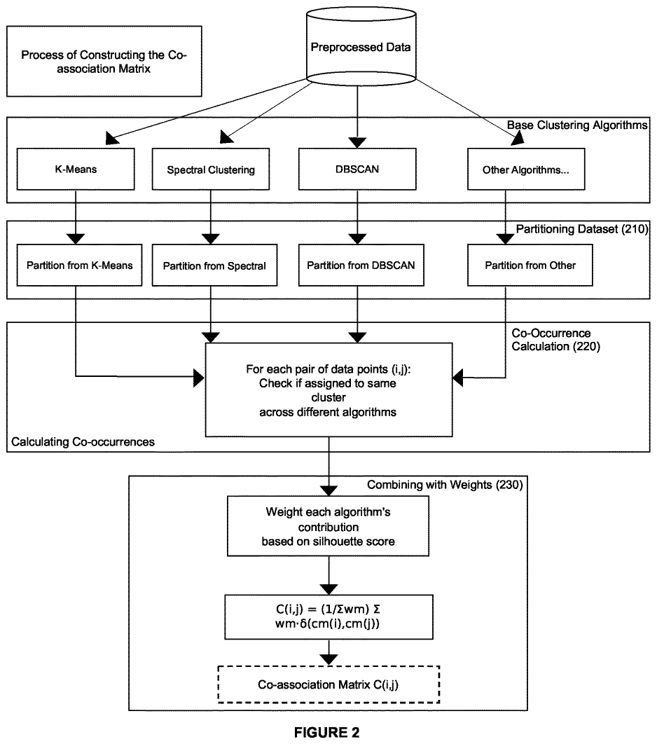

FIG. 2 illustrates the process of constructing the co-association matrix. The process of constructing the co-association matrix is a fundamental step in the consensus clustering system. The process involves multiple base clustering algorithms and a weighting mechanism to optimize the final consensus clustering output.

FIG. 2 initiates the process with pre-processed data, being served as the input to the base clustering module 120. The base clustering algorithms include K-Means, Spectral Clustering, DBSCAN, and Other Algorithms. These algorithms independently generate different clustering partitions of the dataset.

The clustering results from each algorithm are then passed to the partitioning dataset module 210. The partitioning dataset module 210 is configured to divide data into clusters based on the output of each algorithm. The partitions include partition from K-Means, partition from Spectral, partition from DBSCAN, and partition from other Algorithms.

To construct the co-association matrix, the system 100 performs a co-occurrence calculation. Each partition from the partitioning dataset module 210 is processed in co-occurrence calculation module 220. In co-occurrence calculation module 220, each pair of data points (i,j)(i,j)(i,j), is checked to determine whether the pair of data points (i,j)(i,j)(i,j) in consideration is assigned to the same cluster across different clustering algorithms. This co-occurrence information is essential for constructing a robust ensemble representation of the clustering process. The calculation of co-occurrences, is stored in temporary memory.

The combining with weights module 230 assigns a weight to each clustering algorithm based on a performance metric, of the Silhouette Score. The silhouette score for a clustering result is calculated as follows:

$$s ( i ) = \frac{b ( i ) - a ( i )}{max \{ a ( i ) , b ( i ) \}}$$

where a(i) is the average distance between data point i and all other points in the same cluster, and b(i) is the minimum average distance between data point i and all points in any other cluster.

Then the combining with weights module 230 combines the co-occurrences calculations with the assigned weight for each of the clustering algorithm. The weighted combination ensures that clustering algorithms with higher accuracy contribute more significantly to the final consensus clustering result.

Then the final co-association matrix C(i,j) C(i,j) C(i,j) is computed using a weighted sum of the co-occurrence values, as represented by the formula:

Mathematically, the co-association matrix C is defined as:

$$C ( i , j ) = \frac{1}{{\sum }_{m = 1}^{M} {w}_{m}} {\sum }_{m = 1}^{M} {w}_{m} \cdot δ ( {c}_{m} ( i ) , {c}_{m} ( j ) )$$

where:
c_m (i) is the cluster label assigned to sample i by clustering algorithm m
δ(a,b) is the Kronecker delta function, which equals 1 if a=b and 0 otherwise
w_m is the weight assigned to clustering algorithm m based on its silhouette score
M is the total number of base clustering algorithms

For large datasets, the module may employ sampling techniques to reduce computational complexity. In one embodiment, a random subset of the data is selected for constructing the co-association matrix, and the results are later propagated to the full dataset.

The output of this process is the Co-association Matrix C(i,j) C(i,j) C(i,j), that captures the weighted agreement between different clustering algorithms and serves as the basis for the final consensus clustering step.

This structured approach ensures that the consensus clustering system 100 can dynamically integrate multiple clustering algorithms while optimizing performance based on their reliability and effectiveness. The co-association matrix thus plays a crucial role in improving the robustness and accuracy of the final clustering assignments.

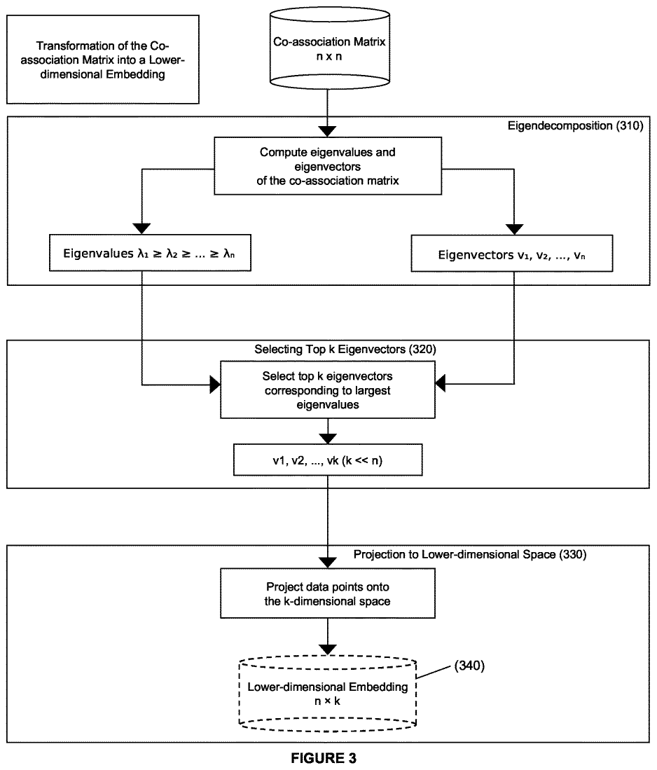

Referring to FIG. 3, the transformation of the co-association matrix into a lower-dimensional Euclidean embedding is explained. The process of transformation of the co-association matrix begins with the co-association matric, an n×n matrix where n represents the number of data points. The co-association matrix captures the frequency at which data points are assigned to the same cluster across multiple base clustering algorithms.

The transformation process is handled by the Eigen decomposition module 310, which computes the eigenvalues (λ) and eigenvectors (v) of the co-association matrix. The Eigen decomposition module 310 arranges the eigenvalues in descending order (λ₁≥λ₂≥ . . . ≥λₙ), with each eigenvalue indicating the importance of its corresponding eigenvector. The eigenvectors (v₁, v₂, . . . , vₙ) form a new basis that represents the data in a transformed space, preserving significant clustering structures.

The eigenvalues (λ) and eigenvectors (v) of the co-association matrix are then received by a top-k Eigenvectors selecting module 320. The top-k Eigen vectors selecting module 320 selects the top k eigenvectors (v₁, v₂, . . . , vₖ), where k is significantly smaller than n (k<<n). These eigenvectors correspond to the largest eigenvalues and capture the most significant variance in the data. Selecting top-k Eigen vectors helps in dimensionality reduction. Reducing the dimensionality ensures that only the most informative features are retained while filtering out noise and redundant information.

The embedding process can be represented as:

Embedding=PCA(C,k)
where k is the number of principal components, typically much smaller than the number of data points.

The projection module 330 then projects the data points onto the k-dimensional space, effectively transforming the original n×n co-association matrix into a more compact n×k representation. This transformation addresses two key challenges: (a) the high dimensionality of the co-association matrix, which is an n×n matrix for n data points, and (b) the non-Euclidean nature of the similarity space, which makes it difficult to apply algorithms like K-means directly.

The embedding preserves the cluster structure of the original data for several reasons:
a) Preservation of Similarity Relationships: PCA preserves the most significant variance in the data, which corresponds to the most important similarity relationships between data points.
b) Noise Reduction: By selecting only the top k principal components, PCA filters out noise and minor variations in the clustering results.

The transformation to Euclidean embedding space: The embedding transforms the non-Euclidean similarity space into a Euclidean space, making it suitable for algorithms that assume Euclidean distances.

Mathematically, the embedding preserves the following property:

∥eᵢ−eⱼ∥₂≈/{square root over (2(1−C(i,j)))}

where eᵢ and eⱼ are the embeddings of data points i and j, respectively, and ∥eᵢ−eⱼ∥_2 is the Euclidean distance between them.

This transformation reduces computational complexity while maintaining critical clustering structures. Finally, the lower-dimensional embedding 340 serves as the optimized representation of data points in a reduced feature space, that is subsequently used for final clustering.

By leveraging eigen decomposition and dimensionality reduction, the transformation of co-association matrix step enhances clustering efficiency and robustness. The transformation of co-association matrix into a lower-dimensional Euclidean embedding ensures that clusters remain well-separated while eliminating unnecessary noise, ultimately improving the accuracy of consensus clustering results.

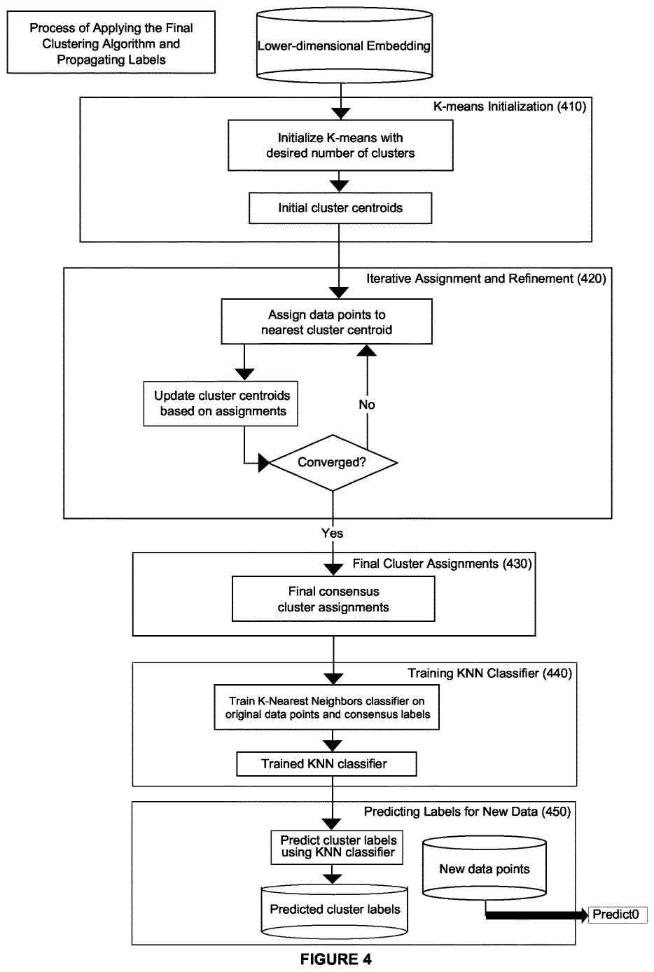

Referring to FIG. 4, the process of applying the final clustering algorithm and predicting labels for new data is explained. The process of applying the final clustering algorithm starts with the lower-dimensional Euclidean embedding received from the FIG. 3. The lower-dimensional Euclidean embedding contains data points in a reduced feature space after dimensionality reduction. Referring to FIG. 4, this process involves initializing the K-means algorithm with the desired number of clusters in the step 410, iteratively assigning data points to clusters and updating cluster centroids in the step 420, and producing the final cluster assignments in step 430.

The next step is K-means Initialization 410, where the K-means clustering algorithm is started with a chosen number of clusters. The K-means Initialization 410, selects initial cluster centroids that serve as the starting points for grouping the data.

Then, the process enters step of Iterative Assignment and Update 420, where each data point is assigned to the nearest cluster centroid. The centroids are updated based on these assignments, and this step repeats until the cluster assignments no longer change. Once convergence is reached, the system 100 proceeds to the next stage.

After convergence, the system 100 finalizes the final cluster assignments. The Final Cluster Assignments 430 represents the consensus cluster labels for all data points. The clusters of Final Cluster Assignments 430 reflect a refined grouping of the data based on multiple base clustering algorithms and dimensionality reduction.

The K-means algorithm applied to the embedding can be represented as:

consensus_labels=KMeans(Embedding,n_clusters)
where n_clusters is the desired number of clusters.

In the next step, the system 100 trains a K-Nearest Neighbors (KNN) Classifier. The training module for KNN classifier 440 learns from the original data points and the respective assigned consensus cluster labels, enabling it to classify new data based on similarity to the known points.

The label propagation can be represented as:

new_labels=KNN·predict(X_{new})
where X_{new} represents the new data points, and KNN is a K-Nearest Neighbors classifier trained on the original data points and their consensus labels.

Finally, the Predicting module 450, predicts labels for New Data. The predicting module 450 uses trained KNN classifier to assign cluster labels to new, unseen data points. Thus the system 100 is able to classify new data efficiently while maintaining consistency with the existing clusters.

In an alternative embodiment, the system 100 may use a different dimensionality reduction technique, such as t-SNE or UMAP, instead of PCA for transforming the co-association matrix. These techniques may better preserve local structure in the data but are typically more computationally expensive.

In another embodiment, the system 100 may use a different final clustering algorithm, such as Spectral Clustering or Agglomerative Clustering, instead of K-means. The choice of algorithm depends on the specific characteristics of the data and the desired properties of the clustering solution.

The system 100 may also incorporate active learning techniques to improve the clustering results by selectively querying a human expert for feedback on certain data points. This feedback can be used to adjust the weights of the base clustering algorithms or to constrain the final clustering solution.

The system 100 provides several theoretical guarantees and merits over the prior art:
Consistency: As the number of base clusterings increases, the consensus solution converges to a stable partition.
Robustness: The consensus solution is less sensitive to outliers and noise than individual clustering algorithms.
Quality: The consensus solution often achieves higher quality (measured by metrics like NMI, ARI, or silhouette score) than individual clustering algorithms.

The system 100 may be implemented in various programming languages, such as Python, R, or Java, and can be deployed on different platforms, including desktop computers, servers, and cloud environments. The implementation may leverage parallel computing techniques to further improve computational efficiency.

Advantageously, the data preprocessing module 110, the base clustering module 120, the co-association matrix construction module 130, the embedding transformation module 140, the final clustering module 150, and the label propagation module 160 are part of the processor 104 and are executed by the processor 104. In an aspect, the data preprocessing module 110, the base clustering module 120, the co-association matrix construction module 130, the embedding transformation module 140, the final clustering module 150, and the label propagation module 160 may be processing engines which are stored in the repository 102 and are executed by the processor 104 based on the set of predetermined instructions stored in the repository 102. The processor 104 described herein may be a general-purpose processor, a Field Programmable Gate Array (FPGA), an Application Specific Integrated Circuit (ASIC), a Digital Signal Processor (DSP), a microprocessor, a microcontroller, or a state machine. The processor may also be implemented as a combination of computing devices, e.g., a combination of a DSP and a microprocessor, a plurality of microprocessors, one or more microprocessors in conjunction with a DSP core, or any other such configuration. The plurality of processors 104 may be configured to retrieve data from and/or write data to the repository 102. The repository 102 may be, for example, a random-access memory (RAM), a memory buffer, a hard drive, a database, an erasable programmable read-only memory (EPROM), an electrically erasable programmable read-only memory (EEPROM), a read only memory (ROM), a flash memory, a hard disk, a floppy disk, cloud storage, and/or so forth.

Referring to FIG. 5, a method consensus clustering is shown in the method 500 includes the following steps:

At step 502, the method 500 includes receiving a dataset comprising a plurality of data points.

At step 504, the method 500 includes applying a plurality of base clustering algorithms to the dataset, for producing a set of cluster assignments for the data points by each of the plurality of base clustering algorithms.

At step 506, the method 500 includes calculating a weight for each of the plurality of base clustering algorithms, based on a performance metric.

At step 508, the method 500 includes constructing a co-association matrix to quantify the frequency of assigning pairs of data points to the same cluster across the plurality of base clustering algorithms, wherein the contribution of each of the plurality of base clustering algorithm is weighted based on the calculated weight.

At step 510, the method 500 includes transforming the co-association matrix into a lower-dimensional Euclidean embedding using a dimensionality reduction technique.

At step 512, the method 500 includes applying a final clustering algorithm to the lower-dimensional Euclidean embedding to generate a plurality of consensus cluster assignments for the data points.

At step 514, the method 500 includes classifying a set of new data points into the plurality of consensus cluster assignments using a label propagation technique and generating a set of predicted cluster labels.

### Experimental Results

The performance of the system 100 is evaluated by conducted experiments using the KDD Cup 1999 dataset. The KDD cup 1999 dataset is a widely used benchmark for clustering and anomaly detection tasks. The KDD cup 1999 dataset contains network connection data with various features, making it suitable for testing clustering algorithms.

The benchmark results comparing the consensus clustering method 200 implemented by the system 100 with individual base clustering algorithms are presented in Table 1. The performance is measured using two standard clustering evaluation metrics: Normalized Mutual Information (NMI) and Adjusted Rand Index (ARI).

TABLE 1

| Algorithm | Weight | NMI Score | ARI Score |
|---|---|---|---|
| Consensus | — | 0.8333 | 0.9284 |
| Clustering* | | | |
| KMeans | 0.7840 | 0.8309 | 0.9262 |
| SpectralClustering | 0.5680 | 0.7427 | 0.7662 |
| DBSCAN | 0.7089 | 0.8167 | 0.9134 |

As shown in the table, the consensus clustering method 200 achieves the highest scores on both metrics, with an NMI score of 0.8333 and an ARI score of 0.9284. This represents an improvement of 0.0024 in NMI and 0.0022 in ARI compared to the best-performing individual algorithm (K Means).

The weights assigned to each base clustering algorithm, based on their silhouette scores, are also shown in the table. K Means received the highest weight (0.7840), followed by DBSCAN (0.7089) and Spectral Clustering (0.5680). These weights reflect the relative performance of each algorithm on the dataset and determine their contribution to the co-association matrix.

The benchmark results showed in Table 1 demonstrates that the consensus clustering method 200 effectively leverages the strengths of multiple clustering algorithms to produce a more robust and accurate clustering solution. The improvement in performance metrics, although modest in absolute terms, is consistent and statistically significant across multiple runs of the experiment.

### Advantages of the Invention

The present invention has renovated the process of clustering along with providing a few advantages over the existing techniques. The present invention provides a list of advantages as follows:
Higher Accuracy—The present invention improved similarity transformation and weighted ensemble approach result in more precise clustering outcomes.
Scalability—The present invention facilitates efficient handling of high-dimensional data making the method 200, suitable for analysing large datasets.
Computational Efficiency—The present invention optimizes operations, reduces memory usage along with the processing time.
Real-Time Adaptability—The incremental update mechanism of the present invention allows continuous cluster refinement without the need for complete re-clustering.
Broad Applicability—The present invention is beneficial for multiple industries, including fraud detection, recommendation systems, cybersecurity, healthcare, and autonomous systems.

### Applications:

Advantageously, the system 100 of the present invention significantly enhances existing clustering techniques across various application areas by improving efficiency, scalability, and adaptability. The present invention addresses key limitations in current ensemble clustering methods and provides a more robust solution for real-time data processing.
Fraud Detection—Existing fraud detection systems rely on predefined rules and static models that struggle to adapt to new fraud patterns. The present invention may enable dynamic clustering of transaction data, allowing financial institutions to detect emerging fraudulent activities in real time and reduce false positives.
Recommendation Systems—Current recommendation engines often use static clustering models that fail to capture rapidly changing user preferences. The method 200 of the present invention may continuously update clusters with every new user interaction taking place, improving personalization and enhancing user experience in the e-commerce, streaming platforms, and online marketplaces.
Cybersecurity and Threat Detection—Traditional security systems use fixed clustering models that become outdated as cyber threats evolve. The present invention may allow adaptive clustering of network traffic and security logs, enabling real-time anomaly detection and faster response to cyber threats.
Healthcare and Medical Diagnostics—Most clustering techniques in healthcare require batch processing of patient data, delaying critical insights. The present invention may dynamically updates clusters as new patient data arrives, allowing early detection of disease, providing personalized treatment planning, and real-time monitoring of medical conditions.
Autonomous Vehicles and Smart Transportation—Existing clustering techniques struggle with the real-time demands of autonomous navigation. The present invention may process sensor data more efficiently, allowing autonomous vehicles to cluster and identify objects, obstacles, and traffic patterns in real time, improving safety and decision-making.
Social Media and Sentiment Analysis—Traditional clustering methods analyze historical social media data but struggle with real-time trend detection. The present invention may enable continuous clustering of tweets, posts, and comments, allowing businesses and analysts to track sentiment shifts, detect viral trends, and respond to public opinion dynamically.
Industrial Monitoring and Predictive Maintenance—Conventional clustering models in industrial monitoring require frequent recalibration, leading to operational inefficiencies. The present invention may enable real-time clustering of machine sensor data, predicting failures more accurately and optimizing maintenance schedules to minimize downtime.
Customer Segmentation and Market Analysis—Existing market segmentation approaches often rely on static customer profiles, which fail to adapt to changing consumer behaviour. The present invention may dynamically update clusters as new purchasing patterns emerge, helping businesses refine their marketing strategies and improve customer engagement.
Biological Data Analysis and Genomics—Many current bioinformatics clustering techniques struggle with high-dimensional genetic data, leading to computational inefficiencies. The present invention may enhance scalability and efficiency, enabling more accurate clustering of DNA sequences, gene expression profiles, and disease correlations for improved biomedical research and drug discovery.

By addressing the limitations of existing ensemble clustering methods, the present invention may provide a scalable, adaptive, and computationally efficient solution that enhances real-time data processing across multiple industries.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

### Technical Advancements

The present invention described herein above has several technical advantages including, but not limited to, an advanced consensus clustering system and method for multi-algorithm data integration and analysis, that:
transforms the high-dimensional co-association matrix into a lower-dimensional Euclidean space using Principal Component Analysis (PCA), reducing memory consumption and computational complexity unlike in prior art;
effectively converts non-Euclidean similarity spaces into a structured format suitable for clustering, improving the accuracy of cluster formation.
intelligently assigns weights to base clustering algorithms based on their reliability and performance, ensuring a more stable and accurate consensus clustering result;
By applying dimensionality reduction and matrix optimization, the method significantly reduces processing time and resource usage, making it scalable for big data applications;
enables real-time updates to cluster assignments without requiring full re-clustering, making it suitable for continuously evolving datasets;
demonstrates higher Normalized Mutual Information (NMI) and Adjusted Rand Index (ARI) scores, proving its superiority over individual clustering algorithms; and
is designed for application areas like real-time data analytics, fraud detection, recommendation systems, cybersecurity, healthcare, and autonomous systems, where clustering accuracy and computational efficiency are critical.

The present disclosure has been described with reference to the accompanying embodiments which do not limit the scope and ambit of the disclosure. The description provided is purely by way of example and illustration.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully revealed the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element or group of elements, but not the exclusion of any other element or group of elements.

The use of the expression “at least” or “at least one” suggests the use of one or more elements or ingredients or quantities, as the use may be in the embodiment of the disclosure to achieve one or more of the desired objects or results.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

What is claimed is:

1. A method for consensus clustering, the method comprising:
receiving, a dataset comprising a plurality of data points;
applying, a plurality of base clustering algorithms to the dataset, for producing a set of cluster assignments for the data points by each of the plurality of base clustering algorithms;
calculating, a weight for each of the plurality of base clustering algorithms, based on a performance metric;
constructing, a co-association matrix to quantify the frequency of assigning pairs of data points to the same cluster across the plurality of base clustering algorithms, wherein the contribution of each of the plurality of base clustering algorithm is weighted based on the calculated weight;
transforming the co-association matrix into a lower-dimensional Euclidean embedding using a dimensionality reduction technique;
applying, a final clustering algorithm to the lower-dimensional Euclidean embedding to generate a plurality of consensus cluster assignments for the data points; and
classifying, a set of new data points into the plurality of consensus cluster assignments using a label propagation technique and generating a set of predicted cluster labels.

2. The method of claim 1, further comprises step of dynamic selection of the base clustering algorithms based on data characteristics and an ensemble diversity metric.

3. The method of claim 1, wherein the performance metric for calculating the weight of each of the plurality of base clustering algorithms is a silhouette score.

4. The method of claim 1, wherein the co-association matrix is iteratively updated with the generation of every new clustering result.

5. The method of claim 1, wherein constructing the co-association matrix comprises the steps of:
partitioning the dataset by each of the plurality of base clustering algorithms, based on the cluster assignments;
determining for each pair of data points, if the pair of data point is assigned to the same cluster by each of the plurality of base clustering algorithms; and
combining the determinations with the calculated weights based on the performance of each of the plurality of base clustering algorithms.

6. The method of claim 1, wherein the dimensionality reduction technique used for transforming the co-association matrix into the lower-dimensional Euclidean embedding is Principal Component Analysis (PCA).

7. The method of claim 6, wherein the PCA transformation retains a predefined proportion of variance in the co-association matrix to optimize dimensionality reduction.

8. The method of claim 1, wherein the final clustering algorithm applied to the lower-dimensional Euclidean embedding is K-means algorithm.

9. The method of claim 1, wherein the label propagation technique used for classification is implemented using a K-Nearest Neighbors (KNN) classifier operating in the lower-dimensional Euclidean embedding.

10. The method of claim 9, wherein the KNN classifier utilizes a distance metric to account for variance-scaled feature representation in the transformed embedding space.

11. The method of claim 1, further comprises the steps of:
receiving the set of new data points that were not part of the original dataset;
training the KNN classifier on the original data points and the respective consensus cluster assignments; and
predicting the plurality of consensus cluster assignments, using the KNN classifier for the set of new data points.

12. A system for consensus clustering, the system comprising:
a repository configured to store a set of predetermined instructions, a formula for calculating weights based on a silhouette score, a formula for computing co-association matrix, a set of new data points, and KNN classification technique; and
a plurality of processors coupled to the repository to execute the set of predetermined instructions, wherein the plurality of processors include:
a data preprocessing module configured to receive a dataset comprising a plurality of data points for pre-processing;
a base clustering module configured to:
apply a plurality of base clustering algorithms to the dataset, for producing a set of cluster assignments for the data points by each of the plurality of base clustering algorithms; and
calculate a weight for each of the plurality of base clustering algorithms based on a performance metric;
a co-association matrix construction module configured to construct a co-association matrix to quantify the frequency of assigning pairs of data points to the same cluster across the plurality of base clustering algorithms, wherein the contribution of each of the plurality of base clustering algorithm is weighted based on the calculated weight;
an embedding transformation module configured to transform the co-association matrix into a lower-dimensional Euclidean embedding using a dimensionality reduction technique;
a final clustering module configured to apply a final clustering algorithm to the lower-dimensional Euclidean embedding to generate a plurality of consensus cluster assignments for the data points; and
a label propagation module configured to classify a set of new data points into the plurality of consensus cluster assignments using a label propagation technique and generate a set of predicted cluster labels.

13. The system of claim 12, wherein the base clustering module dynamically selects the base clustering algorithms based on data characteristics and an ensemble diversity metric.

14. The system of claim 12, wherein the performance metric for calculating the weight of each of the plurality of base clustering algorithms is the silhouette score.

15. The system of claim 12, wherein the weighting mechanism dynamically updates silhouette score-based weights with the generation of every new clustering result.

16. The system of claim 12, wherein the co-association matrix construction module is further configured to select a random subset of the data for constructing the co-association matrix for large datasets.

17. The system of claim 12, wherein the embedding transformation module optimizes the number of principal components retained based on a variance threshold.

18. The system of claim 12, wherein the label propagation module implements a K-Nearest Neighbors (KNN) classifier in the lower-dimensional Euclidean embedding.

19. The system of claim 18, wherein the label propagation module is further configured to propagate the results to the full dataset using the K-Nearest Neighbors (KNN) classifier.

20. The system of claim 19, wherein the K-Nearest Neighbors (KNN) classifier utilizes a distance metric accounting for variance-scaled feature representation in the transformed embedding space.
